(19) United States
(12) Patent Application Publication
(10) Pub. No.: US 2026/0063178 A1
(43) Pub. Date: Mar. 5, 2026

(54) BRAKE MECHANISM, AND LIFTING COLUMN USING BRAKE MECHANISM

(71) Applicant: CHANGZHOU KAIDI ELECTRICAL INC., Changzhou (CN)

(72) Inventors: Tao LIU, Changzhou (CN); Gengxing ZHU, Changzhou (CN); Zhenbin GONG, Changzhou (CN); Jingdong XU, Changzhou (CN)

(21) Appl. No.: 19/385,879

(22) Filed: Nov. 11, 2025

Related U.S. Application Data
(63) Continuation-in-part of application No. 18/941,760, filed on Nov. 8, 2024.
Application No. 18/941,760 is a continuation of application No. PCT/CN2023/106652, filed on Jul. 10, 2023.
Application No. PCT/CN2023/106652 is a continuation of application No. PCT/CN2023/106658, filed on Jul. 10, 2023.

(30) Foreign Application Priority Data
May 11, 2022 (CN) 202210507129.6
May 11, 2022 (CN) 202221136897.7
Dec. 24, 2024 (CN) 2024232071457

(51) Int. Cl. F16D 59/00; F16D 121/16; F16H 25/24

(52) U.S. Cl. CPC F16D 59/00; F16H 25/2454; F16D 2121/16; F16H 2025/2463

(57) ABSTRACT

The present invention discloses a brake mechanism and a lifting column using the brake mechanism, and relates to the technical field of lifting columns. The brake mechanism includes a connecting component, a mounting seat and a self-locking spring, the connecting component includes a first spline part, a intermediate connection part, and a second spline part that are successively disposed, the intermediate connection part includes a cylindrical section and a limiting structure, and the mounting seat is sleeved over the cylindrical section on one side of the limiting structure, and abuts against the limiting structure, to enable the connecting component to circumferentially rotate relative to the mounting seat; and the self-locking spring is sleeved over the cylindrical section on the other side of the limiting structure, and one end of the self-locking spring is limited on the mounting seat. The brake mechanism has a self-locking force value measured before assembly.

### CROSS-REFERENCE TO RELATED APPLICATIONS

The present application is a continuation-in-part of U.S. patent application Ser. No. 18/941,760, filed on Nov. 8, 2024, which is a continuation application of the PCT Patent Application No. PCT/CN2023/106658, filed on Jul. 10, 2023, and the PCT Patent Application No. PCT/CN2023/106652, filed on Jul. 10, 2023, which claim priority to Chinese Patent Application No. 202221136897.7, filed with the State Intellectual Property Office of the People's Republic of China on May 11, 2022, Chinese Patent Application No. 202210507129.6, filed with the State Intellectual Property Office of the People's Republic of China on May 11, 2022, and Chinese Patent Application No. 2024232071457, filed with the State Intellectual Property Office of the People's Republic of China on Dec. 24, 2024, which are incorporated herein by reference in its entirety.

### TECHNICAL FIELD

The present invention relates to the technical field of lifting columns, and specifically, to a brake mechanism and a lifting column using the brake mechanism.

### BACKGROUND

A lifting column includes a bushing component, a transmission assembly, and a motor drive unit, where the transmission assembly is driven to move by using a motor, to expand or contract the bushing component; and is widely applied to height-adjustable furniture or office supplies, such as a bed, a chair, and a desk. Usually, after the motor stops operating, the lifting column slips down due to a load, affecting safety and normal use of a user. This requires that the lifting column needs a self-locking force.

To resolve the foregoing problem, through retrieval, Chinese Patent CN106966345A discloses a telescopic transmission assembly device and a lifting column. A drive device is in transmission collaboration with a transmission screw rod (that is, a solid lead screw). The transmission screw rod is mounted on a fixing plate by using a fourth bearing sleeved at an upper portion of the transmission screw rod, to implement positioning of the transmission screw rod and the fixing plate in an axial direction. A mounting seat is sleeved at an end of the transmission screw rod. A torsion spring is disposed on the mounting seat. The torsion spring is in snap-fit with the fixing plate by using a pin. When the transmission screw rod rotates, the mounting seat and the torsion spring may be driven to rotate. The torsion spring may apply a torsion force to the transmission screw rod in a process of lowering the lifting column, thereby implementing a self-locking function when there is no power input to the transmission screw rod. However, this solution still has relatively large defects: 1) under impact of the load of the lifting column, after the transmission screw rod bears an axial force, especially at a maximum travel, the transmission screw rod is extremely easy to bend and deform, and has the straightness deteriorated; when the lifting column is operating, yawing of the transmission screw rod easily causes shake of the lifting column; moreover, the torsion spring wobbles together with the transmission screw rod, and the self-locking force is unstable; and 2) the self-locking force of the lifting column can be measured only after assembly is completed; if the self-locking force value of the lifting column does not meet a requirement, a self-locking spring needs to be replaced or adjusted after the lifting column is disassembled, which is extremely inconvenient.

Chinese Patent CN208532163U discloses a transmission device and a lifting column. To increase a self-locking force of the entire transmission device, a first braking torsion spring is disposed on a transmission screw rod (that is, a solid lead screw), and a second braking torsion spring is disposed on a hollow spindle (that is, a hollow lead screw). This solution also has disadvantages in CN106966345A. In addition, 1) the structure of this solution is complex and mounting is inconvenient; and 2) because two braking torsion springs are disposed, resistance values of the two braking torsion springs are inconsistent, shake of the lifting column is also easily caused.

### SUMMARY

### 1. Problems to be Resolved

In view of the foregoing technical problems, an objective of the present invention is to provide a brake mechanism, whose self-locking force value can be measured before assembly and whose self-locking stability is high after the brake mechanism is mounted in a lifting column.

Another objective of the present invention is to provide a lifting column having the foregoing brake mechanism.

### 2. Technical Solutions

To achieve the foregoing objectives, the present invention uses the following technical solutions:

A first aspect of the present invention provides a brake mechanism, including a connecting component, a mounting seat, and a self-locking spring, where the connecting component includes a first spline part, an intermediate connection part, and a second spline part that are arranged sequentially along an axis; the intermediate connection part includes a cylindrical section and a limiting structure located on the cylindrical section, the first spline part is threaded through the mounting seat, and the mounting seat is sleeved over the cylindrical section on one side of the limiting structure, and abuts against the limiting structure, to enable the connecting component to circumferentially rotate relative to the mounting seat; and the self-locking spring is sleeved over the cylindrical section on the other side of the limiting structure, and one end of the self-locking spring is limited on the mounting seat. During use, the self-locking spring is first mounted from the side of the first spline part, and the self-locking spring is threaded through the first spline part and is sleeved over a second cylindrical section; and then, the mounting seat is mounted from the side of the first spline part, the mounting seat is sleeved over a first cylindrical section, the self-locking spring is in snap-fit with the mounting seat, and the connecting component, the mounting seat, and the self-locking spring form an integral structure.

The brake mechanism of the present invention can have a self-locking force measured before assembly, and can be mounted after the measurement, so that self-locking force values of a same batch of lifting columns tend to be consistent. When at least two lifting columns operate simultaneously, shake generated due to inconsistent self-locking force values between different lifting columns can be effectively avoided. Moreover, when the brake mechanism is applied to a lifting column, the mounting seat can longitudinally limit the connecting component, thereby effectively avoiding bending or yawing of the connecting component. The self-locking spring is in snap-fit with the mounting seat, thereby improving stability and consistency of self-locking performance of the lifting column.

According to any implementation solution of the first aspect of the objectives of the present invention, the self-locking spring including an end protruding radially outward, the end of the self-locking spring fixed to the mounting seat.

According to any implementation solution of the first aspect of the objectives of the present invention, to facilitate quick mounting of the mounting seat from the side of the first spline part, the cylindrical section includes the first cylindrical section and the second cylindrical section, an outer diameter of the first cylindrical section is less than an outer diameter of the second cylindrical section, the limiting structure is a first retaining step located at a junction of the first cylindrical section and the second cylindrical section, the mounting seat is sleeved over the first cylindrical section, the self-locking spring is sleeved over the second cylindrical section, and one end of the self-locking spring (23) is limited on the mounting seat.

According to any implementation solution of the first aspect of the objectives of the present invention, a second retaining step is formed between the second cylindrical section and the second spline part, and the self-locking spring is limited between the mounting seat and the second retaining step.

According to any implementation solution of the first aspect of the objectives of the present invention, the mounting seat has a mounting hole formed along a central axis, a circular arc surface is formed around an inner side of the mounting hole, and the circular arc surface extends outward to form a step protrusion; a protruding circular platform is formed around an outer side of the mounting hole; an inner wall of the protruding circular platform fits in with the first cylindrical section; and the step protrusion abuts against a limiting step surface.

It should be noted that the inner side and the outer side of the mounting hole have a relative positional relationship along an axial direction of the mounting hole; the protruding circular platform fits in with the first cylindrical section, thereby increasing a contact area between the protruding circular platform and the first cylindrical section, and longitudinally ensuring concentricity of the connecting component and the mounting seat; and the step protrusion abuts against the limiting step surface, where the design of the circular arc surface reduces the contact area between the mounting seat and the limiting step surface, and the step protrusion forms a line contact or even a point contact with the limiting step surface, to reduce friction between the mounting seat and the connecting component transversely, thereby effectively reducing power loss of a motor.

According to any implementation solution of the first aspect of the objectives of the present invention, support plates are formed around the step protrusion, and a height of an end face of the support plate does not exceed a height of an end face of the step protrusion, thereby increasing strength of the step protrusion.

According to any implementation solution of the first aspect of the objectives of the present invention, the limiting structure is a boss located on the cylindrical section, and the boss is disposed near the first spline part.

According to any implementation solution of the first aspect of the objectives of the present invention, the mounting seat has a mounting hole formed along a central axis, a circular arc surface is formed around an inner side of the mounting hole, and the circular arc surface extends outward to form a step protrusion; a protruding circular platform is formed around an outer side of the mounting hole; and the step protrusion abuts against the boss.

According to any implementation solution of the first aspect of the objectives of the present invention, the mounting seat has a plurality of peripheral walls, an upper edge of at least one of the peripheral walls is provided with an outer protruding edge, and an inverted buckle is disposed on at least one of the peripheral walls.

According to any implementation solution of the first aspect of the objectives of the present invention, to ensure that the self-locking spring is motionless relative to the mounting seat, still further, a corner formed by two adjacent peripheral walls is provided with a limiting groove, and the self-locking spring protrudes outward to form a hook, where the hook is embedded in the limiting groove.

According to any implementation solution of the first aspect of the objectives of the present invention, the mounting seat has four peripheral walls, upper edges of opposite peripheral walls on any two sides are provided with outer protruding edges, and inverted buckles are disposed on opposite peripheral walls on the other two sides.

According to any implementation solution of the first aspect of the objectives of the present invention, the peripheral wall provided with the inverted buckle is further provided with an avoidance groove, and the inverted buckle is disposed obliquely upward along a bottom edge of the avoidance groove.

According to any implementation solution of the first aspect of the objectives of the present invention, the protruding circular platform has a height ranging from 0.5 to 1.5 mm and a thickness ranging from 0.5 to 1.5 mm; and a radian of the circular arc surface ranges from 1 to 3 mm, and a height of the step protrusion ranges from 0.1 to 0.3 mm.

According to any implementation solution of the first aspect of the objectives of the present invention, the mounting seat has a plurality of peripheral walls, an upper edge of at least one of the peripheral walls is provided with an outer protruding edge, and an inverted buckle is disposed on at least one of the peripheral walls; and a mounting box is provided with an assembly hole adapting to a peripheral shape of the peripheral wall, and after being pressed and mounted into the assembly hole, the inverted buckle is reset and fastened to the mounting box. The peripheral wall can ensure stability of the mounting seat after mounting, the outer protruding edge facilitates limiting, the inverted buckle facilitates further fixing after mounting, and the assembly hole facilitates connection of the connecting component.

A second aspect of the present invention provides a lifting column, including a mounting box, an inner tube component, an outer tube component, a circular tube, a lead screw, and the brake mechanism according to the first aspect, where a mounting seat of the brake mechanism is in snap-fit with the mounting box; the inner tube component is fixedly connected to the mounting box, the circular tube is disposed in the inner tube component, one end of the circular tube is connected to the brake mechanism, the other end of the circular tube is fixedly connected to a lead screw nut, the lead screw nut is fixedly connected to the inner tube component, one end of the lead screw is threaded through the lead screw nut and located in the circular tube, and the other end of the lead screw is fixedly connected to the outer tube component; and
the brake mechanism includes a connecting component, the mounting seat and a self-locking spring, the connecting component includes a first spline part, a connection part, and a second spline part that are successively disposed, the connection part includes a cylindrical section and a limiting structure, and the mounting seat is sleeved over the cylindrical section on one side of the limiting structure, and abuts against the limiting structure, to enable the connecting component to circumferentially rotate relative to the mounting seat; and the self-locking spring is sleeved over the cylindrical section on the other side of the limiting structure, and one end of the self-locking spring is limited on the mounting seat.

According to any implementation solution of the second aspect of the objectives of the present invention, the limiting structure is a boss located on the cylindrical section, and the boss is disposed near the first spline part; and the self-locking spring is limited between the boss and an end face of the circular tube.

According to any implementation solution of the second aspect of the objectives of the present invention, the cylindrical section includes a first cylindrical section and a second cylindrical section, an outer diameter of the first cylindrical section is less than an outer diameter of the second cylindrical section, the limiting structure is a first retaining step located at a junction of the first cylindrical section and the second cylindrical section, the limiting structure is the first retaining step, the mounting seat is sleeved over the first cylindrical section, and the self-locking spring is sleeved over the second cylindrical section.

### 3. Beneficial Effects

Compared with the existing technology, the present invention has the following beneficial effects:
(1) According to the brake mechanism of the present invention, the mounting seat abuts against the limiting structure of the connecting component, so that the brake mechanism can have the self-locking force value (numerical magnitude) measured before assembly, and can be mounted after the measurement, so that the self-locking force values of the same batch of the lifting columns tend to be consistent. When at least two lifting columns operate simultaneously, shake generated due to inconsistent self-locking force values between different lifting columns can be effectively avoided.
(2) When the brake mechanism is applied to the lifting column of the present invention, the self-locking spring is sleeved over the connecting component. Compared with that the self-locking spring is sleeved over the lead screw, the axial direction of the connecting component is not affected by a load change force. Therefore, the connecting component is uneasy to bend or yaw, and the self-locking force is relatively uniform.
(3) When the brake mechanism is applied to the lifting column of the present invention, the connecting component in the brake mechanism transmits only a torque and does not bear an axial force, the connecting component is uneasy to damage or deform, and the self-locking spring is uneasy to wobble, so that the self-locking force value of the brake mechanism is uneasy to disturb by an external force, and the lifting column has a uniform self-locking force and stable operating performance.

### BRIEF DESCRIPTION OF THE DRAWINGS

The following further describes the technical solutions of the present invention in detail with reference to the accompanying drawings and embodiments. However, it should be noted that these accompanying drawings are merely designed for the purpose of explanation, and therefore are not intended to limit the scope of the present invention. In addition, unless otherwise specified, these accompanying drawings are merely intended to conceptually describe structural constructions described herein, and are not necessarily drawn to scale.

FIG. 1 is a schematic structural diagram of a brake mechanism according to Embodiment 1 of the present invention;

FIG. 2 is a schematic diagram of a cross-sectional structure of the brake mechanism according to Embodiment 1 of the present invention;

FIG. 3 is a schematic structural diagram of a connecting component of the brake mechanism according to Embodiment 1 of the present invention;

FIG. 4 is a schematic structural diagram of a self-locking spring of the brake mechanism according to Embodiment 1 of the present invention;

FIG. 5 is a schematic structural diagram of a mounting seat of the brake mechanism according to Embodiment 1 of the present invention from a viewing angle;

FIG. 6 is a schematic structural diagram of the mounting seat of the brake mechanism according to Embodiment 1 of the present invention from another viewing angle;

FIG. 7 is a schematic diagram of a front-view structure of the mounting seat of the brake mechanism according to Embodiment 1 of the present invention;

FIG. 8 is a schematic diagram of a cross-sectional structure of the mounting seat of the brake mechanism according to Embodiment 1 of the present invention;

FIG. 9 is a schematic structural diagram of a lifting column according to the present invention equipped with the brake mechanism of Embodiment 1;

FIG. 10 is a schematic structural diagram of a connecting component of a brake mechanism according to Embodiment 2 of the present invention; and

FIG. 11 is a schematic structural diagram of a lifting column according to the present invention equipped with the brake mechanism of Embodiment 2.

### DESCRIPTIONS OF REFERENCE NUMERALS

1: mounting box;
2: brake mechanism; 21: connecting component; 211: first spline part; 212: connection part; 2121: first cylindrical section; 2122: second cylindrical section; 2123: first retaining step; 2124: second retaining step; 2125: boss; 213: second spline part; 22: mounting seat; 221: mounting hole; 2211: circular arc surface; 2212: step protrusion; 2213: protruding circular platform; 2214: support plate; 222: peripheral wall; 2221: outer protruding edge; 2222: inverted buckle; 2223: avoidance groove; 2224: limiting groove; 23: self-locking spring; 231: hook;
3: inner tube component;
4: outer tube component;
5: circular tube;
6: lead screw; and
7: lead screw nut.

### DETAILED DESCRIPTION

The present disclosure may be understood more easily with reference to the following description together with the accompanying drawings and examples, and all of the accompanying drawings and the examples form a part of the present disclosure. It should be understood that the present disclosure is not limited to the specific products, methods, conditions, or parameters described and/or shown in this specification. Further, the terms used in this specification are merely used for describing particular embodiments by using examples, and are not intended to limit the embodiments unless otherwise specified.

It should be further understood that, for the purpose of clarity, some features of the present disclosure may be described in this specification in the context of separate embodiments, but may also be provided in a combination with each other in a single embodiment. That is, unless obviously incompatible or specifically excluded, each individual embodiment is deemed to be combinable with any other embodiment and such a combination is considered to represent another different embodiment. On the contrary, various features of the present disclosure described in the context of a single embodiment for the sake of brevity may be provided separately or in any sub-combination. Finally, while a particular embodiment may be described as part of a series of steps or part of a more general structure, each said step or substructure may also be considered as an independent embodiment in itself.

Unless otherwise noted, it should be understood that each individual element in a list and each combination of individual elements in the list are to be explained as different embodiments. For example, a list of embodiments represented as “A, B, or C” should be interpreted as including the embodiments “A”, “B”, “C”, “A or B”, “A or C”, “B or C”, or “A, B, or C”.

In the present disclosure, singular forms of the articles “a”, “an”, and “the” further include corresponding plural referents, and reference to a particular value includes at least the particular value, unless otherwise clearly indicated in the context. Therefore, for example, reference to “a substance” is reference to at least one of the substance and an equivalent thereof.

Terms including ordinal numbers such as “first” and “second” may be used to explain various components or flows, but these components or flows are not limited by these terms. Therefore, without departing from the teaching of the present disclosure, these terms are only used to differentiate a component/flow from another component/flow.

When items are described by using conjunctive terms “ . . . and/or . . . ”, the description should be understood as including any one of the associated listed items and all combinations of one or more thereof.

Usually, use of the term “about” represents an approximation that may vary according to expected properties obtained by using the disclosed subject, and will be explained in a context-dependent manner based on functions. Therefore, a person of ordinary skill in the art can explain differences to some extent on a case-by-case basis. In some cases, the number of significant figures used when a particular value is expressed may be a representative technology used for determining a difference allowed by the term “about”. In other cases, a gradient in a series of values may be used to determine a range of the difference allowed by the term “about”. Further, all ranges in the present disclosure are inclusive and combinable, and reference to values described in a range includes each value in the range.

Unless otherwise defined, all technical and scientific terms used in this specification have the same meaning as those commonly understood by a person skilled in the art to which the present invention belongs. The term and/or used in this specification includes any and all combinations of one or more related listed items.

### Embodiment 1

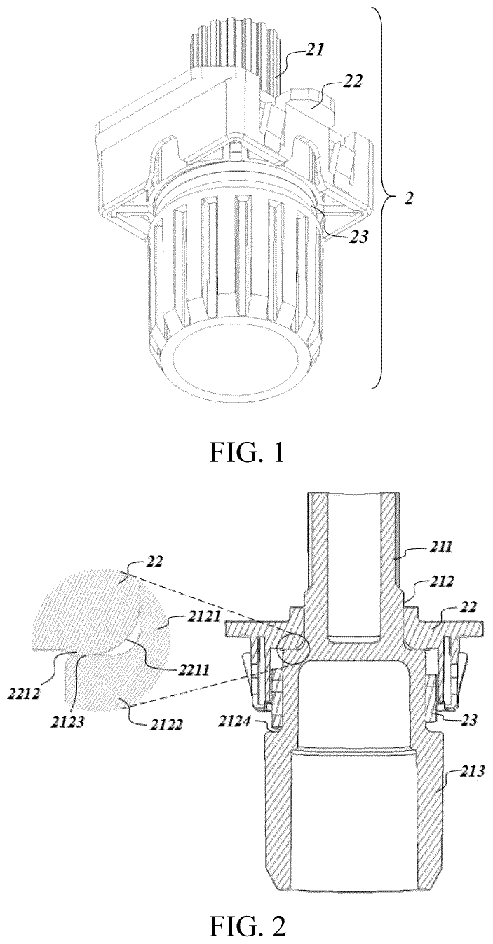

As shown in FIG. 1 and FIG. 2, a brake mechanism 2 in this embodiment includes a connecting component 21, a mounting seat 22 and a self-locking spring 23.

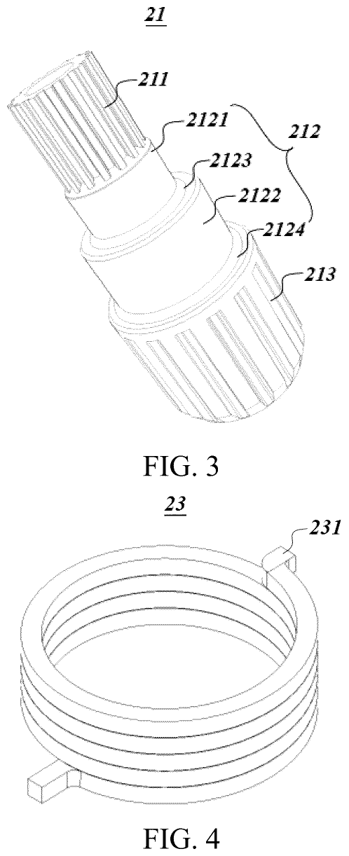

With reference to FIG. 3, the connecting component 21 includes a first spline part 211, an intermediate connection part 212, and a second spline part 213 that are successively disposed, the intermediate connection part 212 includes a cylindrical section and a limiting structure, the cylindrical section includes a first cylindrical section 2121 and a second cylindrical section 2122, and outer diameters of the first cylindrical section 2121, the second cylindrical section 2122, and the second spline part 213 increase successively; the limiting structure is a first retaining step 2123 located at a junction of the first cylindrical section 2121 and the second cylindrical section 2122; and a second retaining step 2124 is formed at a junction of the second cylindrical section 2122 and the second spline part 213, the self-locking spring 23 is sleeved over the second cylindrical section 2122, and the mounting seat 22 is sleeved over the first cylindrical section 2121, and is in snap-fit with the self-locking spring 23.

During use, the self-locking spring 23 is first mounted on the side of the first spline part 211; and then the mounting seat 22 is mounted from the side of the first spline part 211, the self-locking spring 23 is limited between the mounting seat 22 and the second retaining step 2124, the self-locking spring 23 is in snap-fit with the mounting seat 22, and the connecting component 21, the mounting seat 22, and the self-locking spring 23 form an integral structure.

According to the foregoing structural design, the brake mechanism can have a self-locking force measured before assembly, and can be mounted after the measurement, so that self-locking force values of a same batch of lifting columns tend to be consistent. When at least two lifting columns operate simultaneously, shake generated due to inconsistent self-locking force values between different lifting columns can be effectively avoided.

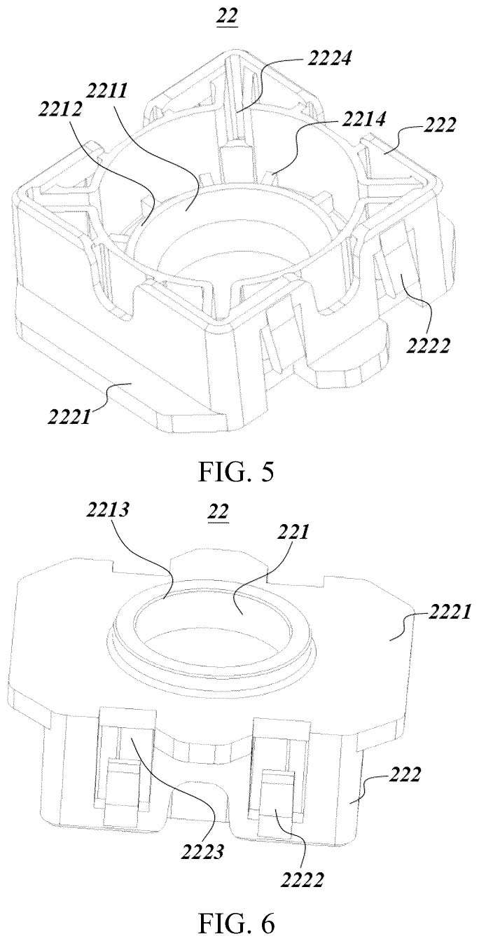

With reference to FIG. 2, FIG. 5, and FIG. 6, the mounting seat 22 has a mounting hole 221 formed along a central axis, a circular arc surface 2211 is formed around an inner side of the mounting hole 221, and the circular arc surface 2211 extends outward to form a step protrusion 2212; a protruding circular platform 2213 is formed around an outer side of the mounting hole 221; and the inner side and the outer side of the mounting hole 221 have a relative positional relationship along an axial direction of the mounting hole 221.

An inner wall of the protruding circular platform 2213 fits in with the first cylindrical section 2121, thereby increasing a contact area between the protruding circular platform and the first cylindrical section, and longitudinally ensuring concentricity of the connecting component 21 and the mounting seat 22; and the step protrusion 2212 abuts against a limiting step surface 2123, where the design of the circular arc surface 2211 reduces the contact area between the mounting seat 22 and the limiting step surface 2123, and the step protrusion 2212 forms a line contact or even a point contact with the limiting step surface 2123, to reduce friction between the mounting seat 22 and the connecting component 21 transversely as shown in FIG. 2, thereby effectively reducing power loss of a motor.

Further, as shown in FIG. 2, to facilitate quick mounting of the mounting seat 22 from the side of the first spline part 211, an inner diameter of the mounting hole 221 is greater than an outer diameter of the first spline part 211.

With reference to FIG. 5, to increase strength of the step protrusion 2212, support plates 2214 are formed around the step protrusion 2212, the support plates 2214 are distributed radially and circumferentially, and a height of an end face of the support plate 2214 does not exceed a height of an end face of the step protrusion 2212, to avoid motion interference between the support plate 2214 and the limiting step surface 2123.

The connecting component 21 in this embodiment is integrally pressed and formed, the protruding circular platform 2213 has a height of 0.5 mm and a thickness of 1 mm, a length of a corresponding connecting component is increased, and a change of the length of the connecting component makes a travel longer; and a radian of the circular arc surface 2211 is 1.5 mm, and a height of the step protrusion 2212 is 0.2 mm, making it possible to implement point contact and reduce friction.

To ensure that the self-locking spring 23 is motionless relative to the mounting seat 22, as shown in FIG. 4 and FIG. 5, still further, a corner formed by two adjacent peripheral walls 222 is provided with a limiting groove 2224, and the self-locking spring 23 protrudes outward to form a hook 231, where the hook 231 is embedded in the limiting groove 2224.

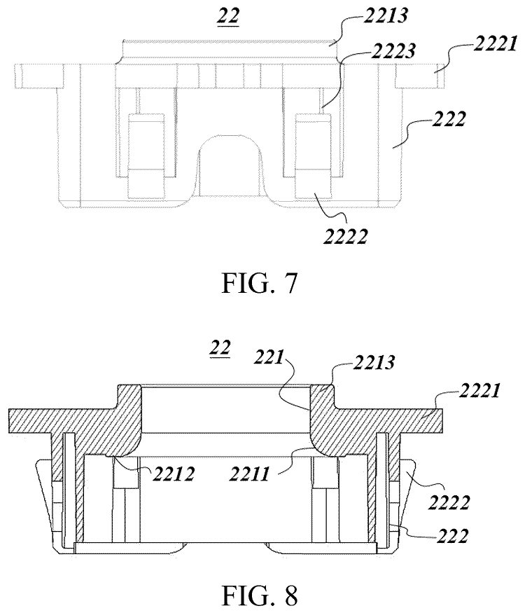

Preferably, as shown in FIG. 5 to FIG. 8, the mounting seat 22 has four peripheral walls 222, upper edges of opposite peripheral walls 222 on any two sides are provided with outer protruding edges 2221, and inverted buckles 2222 are disposed on opposite peripheral walls 222 on the other two sides. Further, the peripheral wall 222 provided with the inverted buckle 2222 is further provided with an avoidance groove 2223, and the inverted buckle 2222 is disposed obliquely upward along a bottom edge of the avoidance groove 2223.

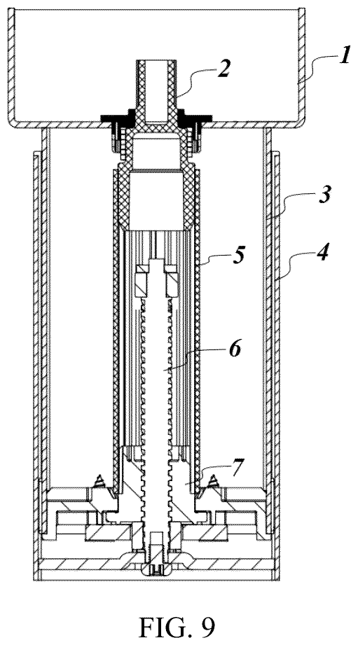

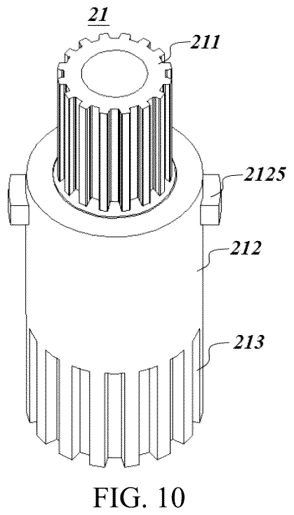

As shown in FIG. 9, this embodiment provides a lifting column, including a mounting box 1, an inner tube component 3, an outer tube component 4, a circular tube 5, a lead screw 6, and a brake mechanism 2, where a mounting seat 22 of the brake mechanism 2 is clamped in the mounting box 1; and one end of the inner tube component 3 is fixedly connected to the mounting box 1, the circular tube 5 is disposed in the inner tube component 3, one end of the circular tube 5 is connected to the mounting box 1 by using the brake mechanism, the other end of the circular tube 5 is fixedly connected to a lead screw nut 7, the lead screw nut 7 is fixedly connected to the other end of the inner tube component 3, one end of the lead screw 6 is threaded through the lead screw nut 7 and located in the circular tube 5, and the other end of the lead screw 6 is fixedly connected to the outer tube component 4.

Further, the mounting box 1 is provided with an assembly hole adapting to a peripheral shape of the peripheral wall 222, and after being pressed and mounted into the assembly hole, the inverted buckle 2222 is reset and fastened to the mounting box 1. The peripheral wall 222 can ensure stability of the mounting seat 22 after mounting, the outer protruding edge 2221 facilitates limiting, the inverted buckle 2222 facilitates further fixing after mounting, and the assembly hole facilitates connection of the connecting component 21.

When the outer tube component 4 bears a force, the outer tube component 4 first transmits the force to the lead screw 6, and then transmits the force to the inner tube component 3 and the mounting box 1 through the lead screw nut 7 sleeved over the lead screw 6, so that the circular tube 5 basically does not bear an axial force or a load force, but transmits only a torque, and the connecting component 21 of the brake mechanism 2 connected to the circular tube 5 does not bear an axial force either. Therefore, the connecting component 21 is not easy to damage or deform. The self-locking spring 23 is sleeved over the connecting component 21, an axial size of the connecting component 21 is small, and non-uniformity of the self-locking force or failure of the self-locking force caused by a phenomenon such as bending or yawing does not occur. In addition, the self-locking spring 23 is uneasy to wobble, so that the self-locking force value of the brake mechanism 2 is uneasy to disturb by an external force, and the lifting column has a uniform self-locking force and stable operating performance.

### Embodiment 2

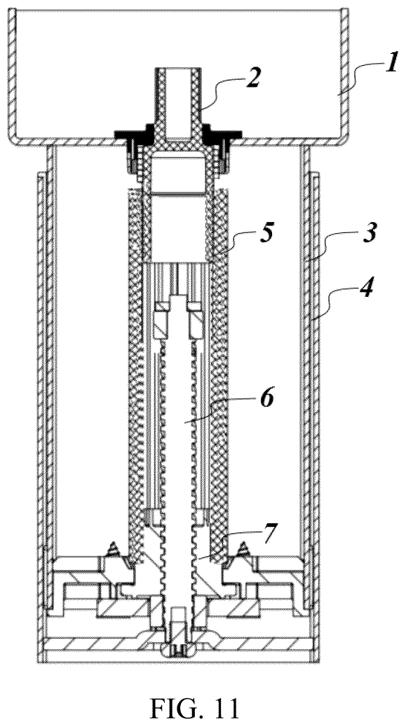

As shown in FIG. 10 and FIG. 11, a difference between the brake mechanism of this embodiment and that of Embodiment 1 lies in that the limiting structure is a boss 2125 located on the cylindrical section (in this case, a diameter of the first cylindrical section may be the same as or different from a diameter of the second cylindrical section), and the boss 2125 is disposed near the first spline part 211; and the self-locking spring 23 is limited between the boss 2125 and an end face of the circular tube 5.

In this embodiment, the protruding circular platform 2213 of the mounting seat 22 collaborates with the cylindrical section, thereby increasing a contact area between the protruding circular platform and the cylindrical section, and longitudinally ensuring concentricity of the connecting component 21 and the mounting seat 22; and the step protrusion 2212 abuts against the boss 2125, where the design of the circular arc surface 2211 reduces the contact area between the mounting seat 22 and the boss 2125, and the step protrusion 2212 forms a line contact or even a point contact with the boss 2125, to reduce friction between the mounting seat 22 and the connecting component 21 transversely, thereby effectively reducing power loss of the motor.

It is apparent to a person skilled in the art that the present invention is not limited to details in the foregoing exemplary embodiments, and the present invention can be implemented in another specific form without departing from the spirit or basic features of the present invention. Therefore, the embodiments should be considered to be exemplary in all respects and not limitative. The scope of the present invention is not defined by the foregoing description but by the appended claims. The present invention is intended to include all the variations that are equivalent in significance and scope to the claims. Any reference numerals in the claims should not be construed as limiting the claims involved.

What is claimed is:

1. A brake mechanism, comprising:
a connecting component (21), a mounting seat (22), and a self-locking spring (23), wherein:
the connecting component (21) includes a first spline part (211), an intermediate connection part (212), and a second spline part (213) that are successively arranged along an axis;
the intermediate connection part (212) includes a first cylindrical section (2121) and a second cylindrical section (2122);
the mounting seat (22) is mounted onto the first cylindrical section (2121), and the connecting component (21) performs a circumferential rotation relative to the mounting seat (22); and
the self-locking spring (23) is mounted onto the second cylindrical section (2122), and one end of the self-locking spring (23) is limited on the mounting seat (22).

2. The brake mechanism according to claim 1, wherein the intermediate connection part (212) further includes a limiting structure located between the first cylindrical section (2121) and the second cylindrical section (2122), and one end of the mounting seat (22) is axially limited by using the limiting structure.

3. The brake mechanism according to claim 2, wherein an outer diameter of the first cylindrical section (2121) is less than an outer diameter of the second cylindrical section (2122), a first retaining step (2123) is formed at a junction of the first cylindrical section (2121) and the second cylindrical section (2122), and the limiting structure is the first retaining step (2123).

4. The brake mechanism according to claim 3, wherein a second retaining step (2124) is formed between the second cylindrical section (2122) and the second spline part (213), and the self-locking spring (23) is limited between the mounting seat (22) and the second retaining step (2124).

5. The brake mechanism according to claim 3, wherein the mounting seat (22) has a mounting hole (221) formed along a central axis, a circular arc surface (2211) is formed around an inner side of the mounting hole (221), and the circular arc surface (2211) extends outward to form a step protrusion (2212); a protruding circular platform (2213) is formed around an outer side of the mounting hole (221); an inner wall of the protruding circular platform (2213) fits in with the first cylindrical section (2121); and the step protrusion (2212) abuts against the first retaining step (2123).

6. The brake mechanism according to claim 5, wherein support plates (2214) are formed around the step protrusion (2212), and a height of an end face of the support plate (2214) does not exceed a height of an end face of the step protrusion (2212).

7. The brake mechanism according to claim 2, wherein the limiting structure is a boss (2125) located between the first cylindrical section (2121) and the second cylindrical section (2122), and the boss (2125) is disposed near the first spline part (211).

8. The brake mechanism according to claim 7, wherein the mounting seat (22) has a mounting hole (221) formed along a central axis, a circular arc surface (2211) is formed around an inner side of the mounting hole (221), and the circular arc surface (2211) extends outward to form a step protrusion (2212); a protruding circular platform (2213) is formed around an outer side of the mounting hole (221); and the step protrusion (2212) abuts against the boss (2125).

9. The brake mechanism according to any one of claim 2, wherein the mounting seat (22) has a plurality of peripheral walls (222), an upper edge of at least one of the peripheral walls (222) is provided with an outer protruding edge (2221), and an inverted buckle (2222) is disposed on at least one of the peripheral walls (222).

10. The brake mechanism according to claim 9, wherein a corner formed by two adjacent peripheral walls (222) is provided with a limiting groove (2224), and the self-locking spring (23) protrudes outward to form a hook (231), wherein the hook (231) is embedded in the limiting groove (2224).

11. The brake mechanism according to claim 10, wherein the mounting seat (22) has four peripheral walls (222), upper edges of opposite peripheral walls (222) on any two sides are provided with outer protruding edges (2221), and inverted buckles (2222) are disposed on opposite peripheral walls (222) on the other two sides.

12. The brake mechanism according to claim 11, wherein the peripheral wall (222) provided with the inverted buckle (2222) is further provided with an avoidance groove (2223), and the inverted buckle (2222) is disposed obliquely upward along a bottom edge of the avoidance groove (2223).

13. The brake mechanism according to claim 5, wherein the protruding circular platform (2213) has a height ranging from 0.5 to 1.5 mm and a thickness ranging from 0.5 to 1.5 mm; and a radian of the circular arc surface (2211) ranges from 1 to 3 mm, and a height of the step protrusion (2212) ranges from 0.1 to 0.3 mm.

14. The brake mechanism according to claim 8, wherein the protruding circular platform (2213) has a height ranging from 0.5 to 1.5 mm and a thickness ranging from 0.5 to 1.5 mm; and a radian of the circular arc surface (2211) ranges from 1 to 3 mm, and a height of the step protrusion (2212) ranges from 0.1 to 0.3 mm.

15. A lifting column, comprising a mounting box (1), an inner tube component (3), an outer tube component (4), a brake mechanism (2), a circular tube (4), and a lead screw (6), wherein a mounting seat (22) of the brake mechanism (2) is in snap-fit with the mounting box (1); and the inner tube component (3) is fixedly connected to the mounting box (1), the circular tube (5) is disposed in the inner tube component (3), one end of the circular tube (5) is connected to the brake mechanism (2), the other end of the circular tube (5) is fixedly connected to a lead screw nut (7), the lead screw nut (7) is fixedly connected to the inner tube component (3), one end of the lead screw (6) is threaded through the lead screw nut (7) and located in the circular tube (5), and the other end of the lead screw (6) is fixedly connected to the outer tube component (4); wherein
the brake mechanism (2) comprises a connecting component (21), a mounting seat (22) and a self-locking spring (23), the connecting component (21) comprises a first spline part (211), an intermediate connection part (212), and a second spline part (213) that are successively disposed, the intermediate connection part (212) comprises a cylindrical section and a limiting structure, and the mounting seat (22) is sleeved over the cylindrical section on one side of the limiting structure, and abuts against the limiting structure, to enable the connecting component (21) to circumferentially rotate relative to the mounting seat (22); and the self-locking spring (23) is sleeved over the cylindrical section on the other side of the limiting structure, and one end of the self-locking spring (23) is limited on the mounting seat (22).

16. The lifting column according to claim 15, wherein the limiting structure is a boss (2125) located on the cylindrical section, and the boss (2125) is disposed near the first spline part (211).

17. The lifting column according to claim 16, wherein the self-locking spring (23) is limited between the boss (2125) and an end face of the circular tube (5).

18. The lifting column according to claim 15, wherein the cylindrical section comprises a first cylindrical section (2121) and a second cylindrical section (2122), an outer diameter of the first cylindrical section (2121) is less than an outer diameter of the second cylindrical section (2122), the limiting structure is a first retaining step (2123) located at a junction of the first cylindrical section (2121) and the second cylindrical section (2122), the limiting structure is the first retaining step (2123), the mounting seat (22) is sleeved over the first cylindrical section (2121), and the self-locking spring (23) is sleeved over the second cylindrical section (2122).
